(19) United States
(12) Patent Application Publication
(10) Pub. No.: US 2026/0021839 A1
(43) Pub. Date: Jan. 22, 2026

(54) COLLAPSIBLE DEVICES WITH HINGE ASSEMBLIES

(71) Applicant: JOURNE BRANDS, INC., Riverside, CA (US)

(72) Inventors: Marcela Mauzer Casarotto, Brunswick (AU); Ryan James Owen, Belgrave (AU); Mark Roman Jaworski, West Footscray (AU)

(21) Appl. No.: 19/274,320

(22) Filed: Jul. 18, 2025

Related U.S. Application Data
(60) Provisional application No. 63/673,335, filed on Jul. 19, 2024.

(51) Int. Cl. B62B 1/20; B62B 1/12

(52) U.S. Cl. CPC B62B 1/208; B62B 1/125; B62B 2205/24

(57) ABSTRACT

A collapsible cart with four panels configured in a rectangular shape, with adjacent panels coupled at their adjacent edges by hinge assemblies that include a nonreleasable fastener with engaging portions that are hidden and not accessible after the fastener is mounted. The hinge assemblies the coupled panels in a manner that enables the panels to move and swing in allowing the cart to move between a collapsed configuration and an expanded configuration.

### CROSS REFERENCE TO RELATED APPLICATION

This application claims the benefit of priority under 35 U.S.C. § 119 to prior filed U.S. Provisional Application No. 63/673,335, filed Jul. 19, 2024, the entire contents of which are incorporated herein by reference.

### FIELD OF INVENTION

The present invention is directed to collapsible devices, including collapsible carts.

### BACKGROUND

Carts are convenient for storing goods. Wheeled carts are convenient for both storing and transporting goods. However, when not in use, carts, wheeled or not, inconveniently occupy space and can themselves pose a storage challenge. Applicant recognized the need to provide a cart device that can transition between an expanded configuration and a collapsed configuration with the use of hinges. In broader applications, Applicant further recognize the need to provide a collapsible design using hinge assemblies for modular assembly and disassembly of connected panels and components, offering versatility and simplicity of installation. Preferably, no tools are required for installation or adjustment and the hinge assemblies enable tool-free installation, streamlining assembly and maintenance procedures. The hinge assembly design allows for greater versatility for positioning within diverse structures or assemblies. It removes the requirement for additional tools during assembly and addresses concerns regarding tool accessibility.

### SUMMARY OF THE INVENTION

In some embodiments, a collapsible cart movable between a collapsed configuration and an expanded configuration, comprises a front panel, a rear panel, a first side panel and a second side panel configured to form a rectangular shape with four corners and a plurality of hinge assembly. Each hinge assembly is located at a respective corner and includes a receiving member, an insert member with a hinge, and a nonreleasable or permanent fastener configured to lock the hinge to the receiving member in enabling adjacent panels of the respective corner to move between about 0 to 90 degrees relative to each other.

In some embodiments, the collapsible cart further comprises a bottom panel configured for stowage next to and parallel with the front panel when the collapsible cart is in the collapsed configuration.

In some embodiments, the receiving member includes an open channel configured to receive the hinge.

In some embodiments, the nonreleasable fastener includes at least one prong with an enlarged end that is configured for engagement with an indentation formed in the receiving member.

In some embodiments, the enlarged end when inserted into the indentation is surrounded in its entirety by the receiving member.

In some embodiments, the collapsible cart further comprises caster wheels.

In some embodiments, the collapsible cart further comprises handles.

In some embodiments, each hinge assembly includes a second receiving member, a second insert member with a second hinge in vertical alignment with the hinge, and a second nonreleasable fastener configured to lock the second hinge to the second receiving member.

In some embodiments, the collapsible cart includes injection molded components.

In some embodiments, a collapsible cart configured to move between a collapsed configuration and an expanded configuration, comprises a front panel, a rear panel, a bottom panel, a first side panel and a second side panel, and a plurality of hinge assembly. Each hinge assembly includes a receiving member with a channel and side indentations, an insert member with a hinge configured to sit in the channel, and a nonreleasable fastener configured with prongs and enlarged ends configured to engage with the side indentations in locking the hinge in the channel.

In some embodiments, the front panel, the rear panel and the first and side panels are configured to form a rectangular shape with corners, a respective hinge assembly situated in a respective corner.

In some embodiments, each hinge assembly pivotably couples adjacent panels at each corner in enabling the adjacent panels to move between at least 0 and 90 degrees relative to each other.

In some embodiments, each of the first side panel and the second side panel comprises a front half panel, a rear half panel, and a hinge joint movably coupling the front half panel and the rear half panel.

In some embodiments, the collapsible cart includes a bottom panel configured for stowage next to and parallel with the front panel when the collapsible cart is in the collapsed configuration.

In some embodiments, a collapsible cart configured to move between a collapsed configuration and an expanded configuration, comprises four panels configured to form a rectangular shape with four corners, each corner comprising a pair of first and second hinged panels, and a plurality of nonreleasable fasteners. The first hinged panel has a first edge comprising upper and lower channels and the second hinged panel has a second edge comprising upper and lower hinges, each hinge configured to sit in a respective channel, and each nonreleasable fastener configured to lock a respective hinge in a respective channel in enabling each pair of first and second hinged panels to move about 0 to 90 degrees relative to each other.

In some embodiments, two opposing panels of the four panels comprises two half panels, each of the two half panels hinged to each other by hinge joints that are configured to enable each of the two half panels to move between about 0 to 180 degrees relative to each other.

In some embodiments, the four panels and the plurality of nonreleasable fasteners are injection molded.

In some embodiments, the cart includes a bottom panel configured for stowage next to and parallel with the front panel when the collapsible cart is in the collapsed configuration.

In some embodiments, each of the nonreleaseable fastener has enlarged ends, and the first hinged panel includes indentations configured to receive the enlarged ends, each indentation configured to surround a respective enlarged end in its entirety.

In some embodiments, the collapsible cart further includes telescopic handles mounted to one of the panels.

### BRIEF DESCRIPTION OF THE DRAWINGS

The drawings and detailed description that follow are intended to be merely illustrative and are not intended to limit the scope of the invention as contemplated by the inventors.

FIG. 1 is a front perspective view of a collapsible cart, in an expanded configuration, according an embodiment of the present invention.

FIG. 2 is a top plan view of the collapsible cart of FIG. 1.

FIG. 3 is a side view of the collapsible cart of FIG. 1.

FIG. 4 is a rear view of the collapsible cart of FIG. 1.

FIG. 5 is a bottom view of the collapsible cart of FIG. 1.

FIG. 6 is a front perspective view of the collapsible cart of FIG. 1, in a folded configuration, according to an embodiment of the present invention.

FIG. 7 is a top plan view of the collapsible cart of FIG. 6.

FIG. 8 is a front perspective view of the collapsible cart of FIG. 1, in a collapsed configuration, according to an embodiment of the invention.

FIG. 9 is a top plan view of the collapsible card of FIG. 8.

FIG. 10A is perspective view of a hinge assembly prior to assembly, according to an embodiment of the present invention.

FIG. 10B is a side view of the hinge assembly of FIG. 10A.

FIG. 11A is a perspective view of the hinge assembly of FIG. 10A, with hinge pins inserted.

FIG. 11B is a side view of the hinge assembly of FIG. 11A.

FIG. 12A is a perspective view of the hinge assembly of FIG. 10A, with hinge pins fastened, according to an embodiment of the present invention.

FIG. 12B is a side view of the hinge assembly of FIG. 12A.

### DETAILED DESCRIPTION OF MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±10% of the recited value, e.g. “about 90%” may refer to the range of values from 81% to 99%.

Any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those skilled in the pertinent art in view of the teachings herein. Such modifications and variations are intended to be included within the scope of the claims.

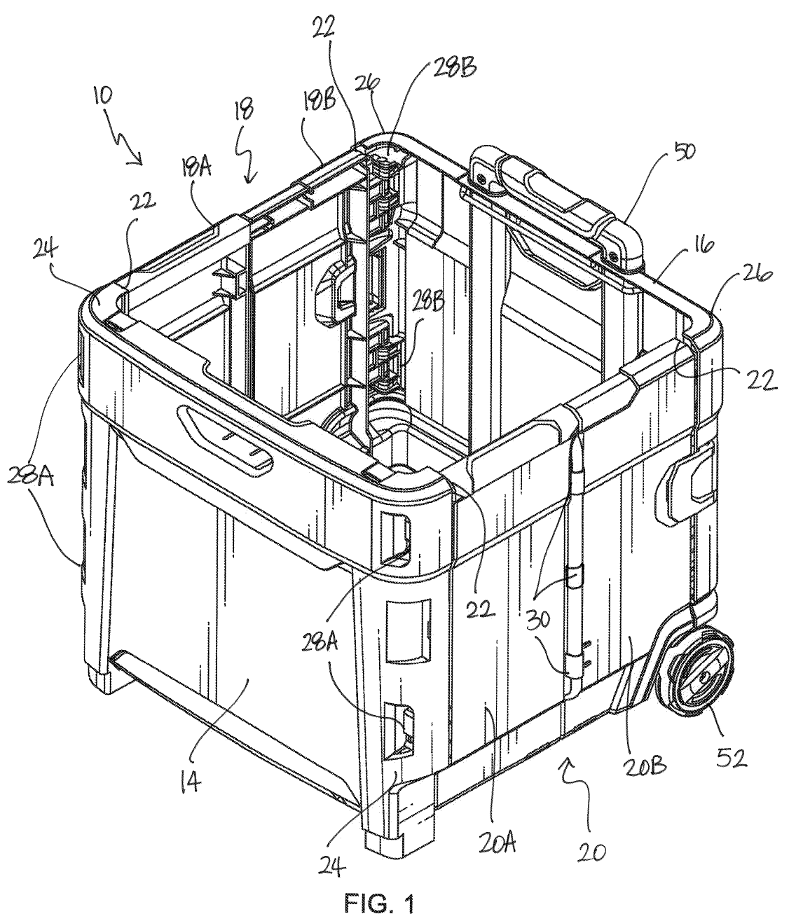

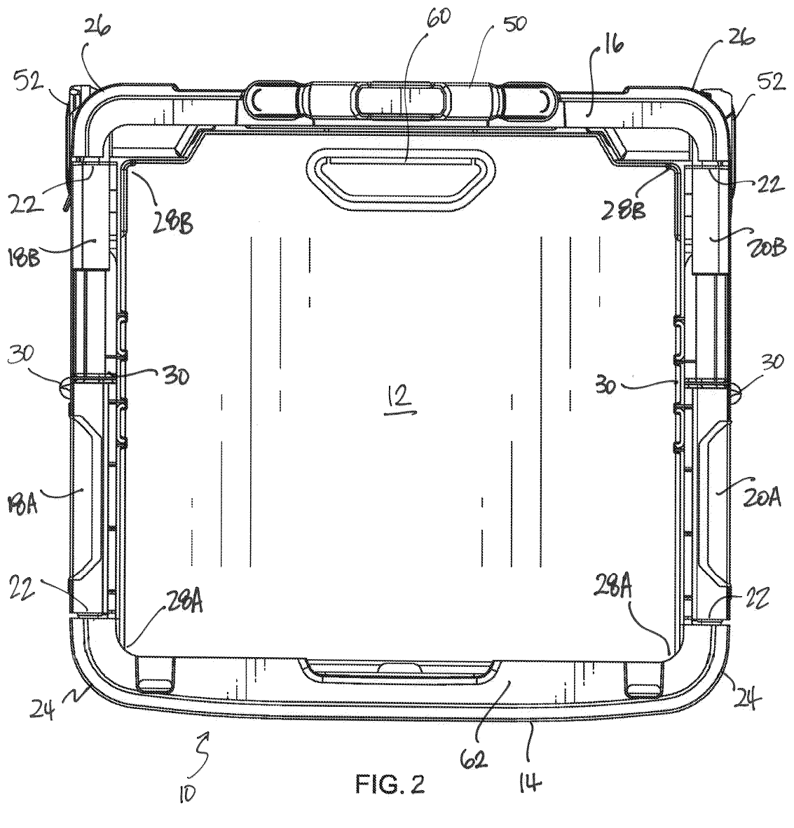

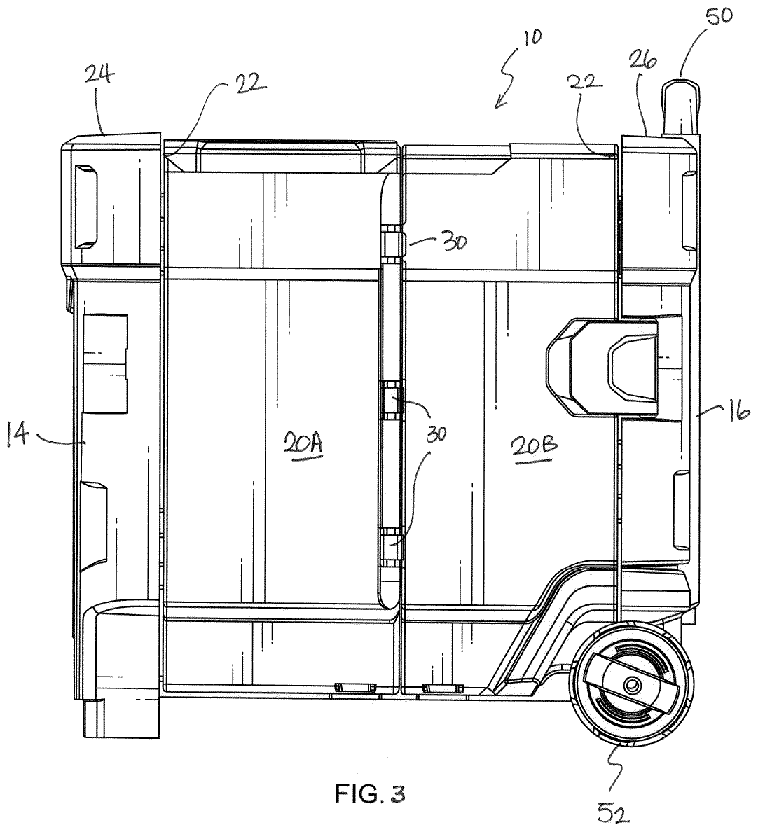

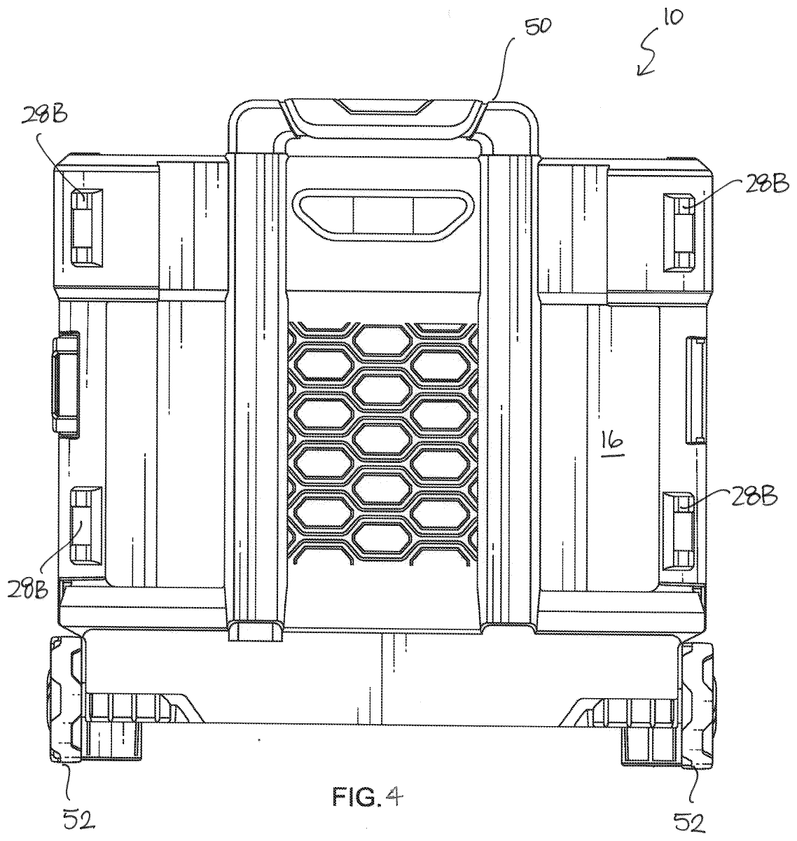

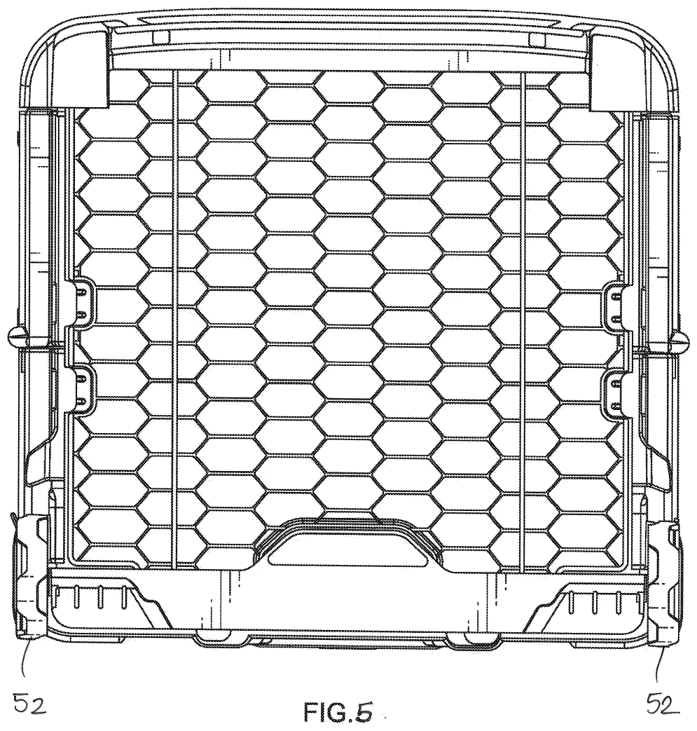

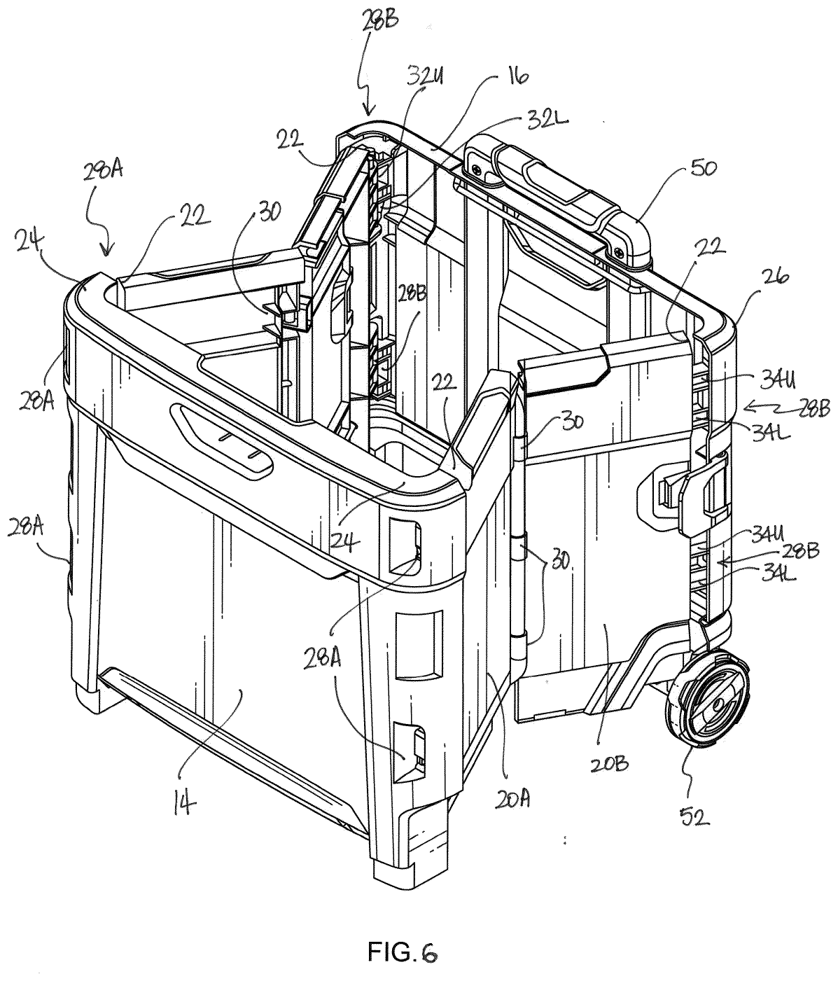

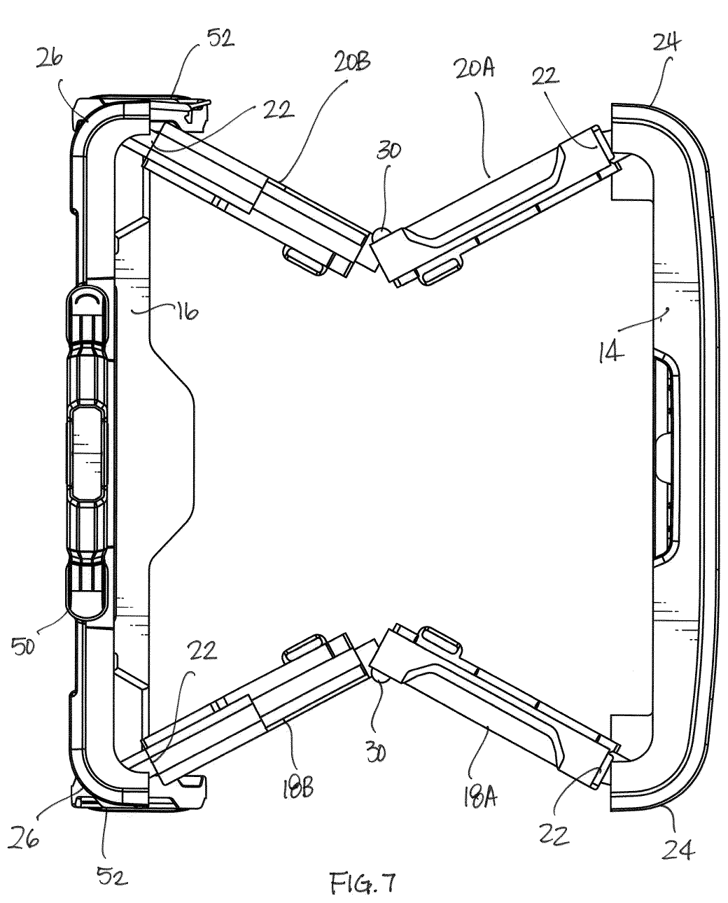

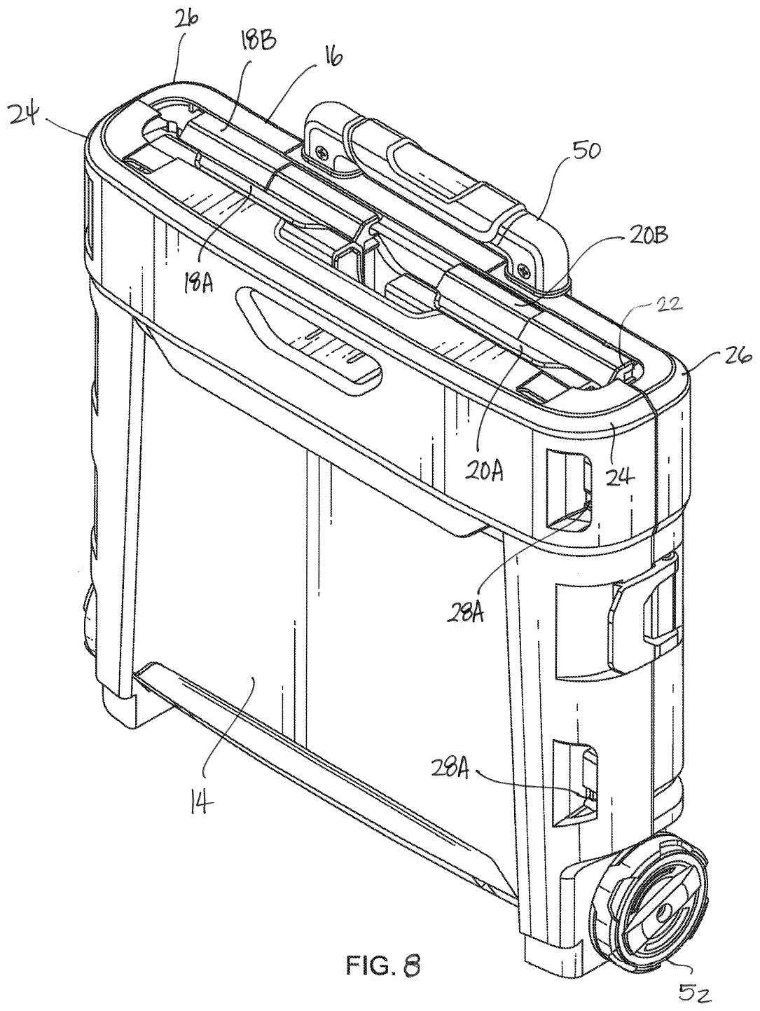

With reference to FIG. 1, FIG. 2, FIG. 3, FIG. 4 and FIG. 5, a collapsible cart 10 includes a bottom panel 12, a front panel 14, a rear panel 16, a first side panel 18 and a second side panel 20 opposing the first side panel 18. The first side panel 18 includes front half panel 18A and rear half panel 18B. The second side panel 20 includes front half panel 20A and rear half panel 20B. The cart 10 can assume an expanded configuration (FIG. 1), a folded configuration (FIG. 6) and a collapsed configuration (FIG. 8) via hinge assemblies extending between selected panels. The side panels 18, 20 include planar bodies that extend to side straight edges 22, the front panel 14 has a planar body with curved side edges 24, and the rear panel 16 has a planar body with curved side edges 26.

In the illustrated embodiment of FIG. 6, first hinge assemblies 28A are provided at curved side edges 24 of the front panel 14 and a front straight edge 22 of each front half panel 18A, 20A. Second hinge assemblies 28B are provided at curved side edges 26 of the rear panel 16 and a rear straight edge 22 of each rear half panel 18B, 20B. Additional hinged joints 30 are provided between the front half panel 18A and the rear half panel 18B, and between the front half panel 20A and the rear half panel 20B.

First hinge assemblies 28A enable the front panel 14 and each front half panel 18A, 20A to move or hinge generally between 0 and 90 degrees relative to each other. Second hinge assembly 28B enables the rear panel 16 and each rear half panel 18B, 20B to move or hinge generally between 0 and 90 degrees relative to each other. Third hinged joints 30 enable the front and rear half panels 18A, 20A, 18B, 20B to move or hinge generally between 0 and 180 degrees relative to each other. As such, the cart 10 can expand into a generally rectangular configuration defining an interior (FIG. 1), be folded (FIG. 6) and collapse flatly into a generally planar configuration (FIG. 8).

Hinge assemblies 28A and 28B function similarly so the description below of hinge assembly 28A is understood to apply to hinge assembly 28B. As shown in FIG. 10A and FIG. 10B, hinge assembly 28A includes a receiving portion 29 and an insertion portion 31. In the illustrated embodiment, the receiving portion 29 includes first or upper receiving members 32U, second or lower receiving members 32L, and the insertion portion 31 includes first or upper insertion members 34U generally opposing first receiving members 32U and second or lower insertion members 34L generally opposing second receiving members 32L. The receiving portion 29, with the first and second receiving members 32U, 32L, is formed on an interior surface of the curved side edges 24 of front panel 14. The insertion portion 31, with the first and second insertion members 34U, 34L, is formed on or near the straight side edge 22 of each front half panel 18A, 20A, facing the first and second receiving members 32U, 32L. Each receiving member 32U, 32L has an upper open channel 35U and a lower open channel 35L, each with a semi-circular cross section facing the interior. The open channels 35U, 35L are arranged in vertical alignment but separated by a space gap 36. On each side of each open channel 35U, 35L, is an indentation 37 formed in each receiving member 32U, 32L.

Each insertion member 34U, 34L of the insertion portion 31 has a vertical hinge pin 38U, 38L, each in the shape of a cylindrical rod, where the hinge pins 38U, 38L are arranged in vertical alignment, with a first spacer 40 of the upper insertion member 34U extending therebetween. In the illustrated embodiment, a second spacer 40L is situated below the hinge pin 38L of the lower insertion member 34L.

Each hinge assembly 28A further includes fasteners 42U, 42L configured to fixedly fasten a respective member 34U, 34L with its hinge pin 38U, 38L of the insertion portion 31 to a respective receiving member 32U, 32L of the receiving portion 29. Each fastener 42U, 42L has a U-shaped cross section with a center portion 43 and two opposing prongs 44, each prong having an enlarged end 45.

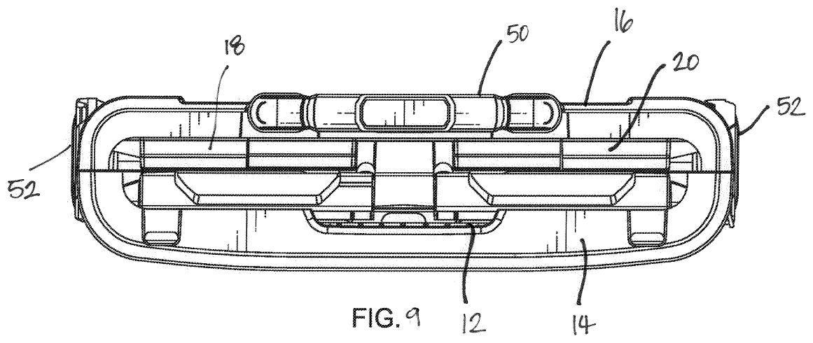

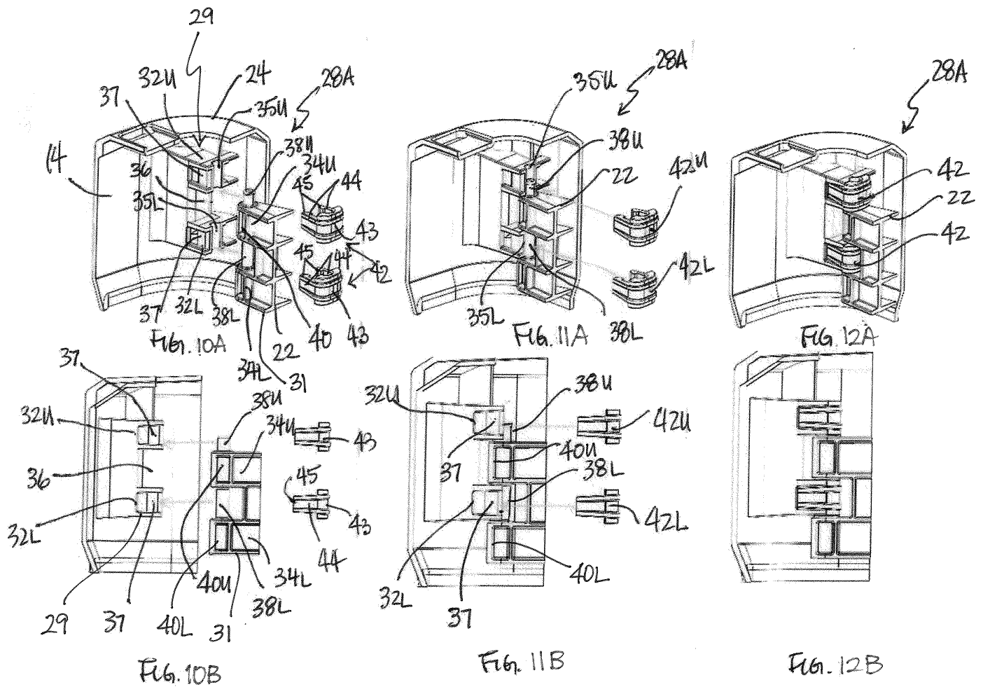

To assemble the front panel 14 and the front half panel 18A, they are placed at 90 degrees to each other with the receiving members 32U, 32L and the insertion member 34U, 34L facing each other, as shown in FIG. 10A and FIG. 10B. As shown in FIG. 11A and FIG. 11B, the hinge pins 38U, 38L of the insertion portion 31 are placed in respective open channels 35U, 35L of the receiving portion 29, with the spacer 40U between the hinge pins 38U, 38L received in the space gap 36 of the receiving member 29. As shown in FIG. 12A and FIG. 12B, a respective fastener 42U, 42L is then mounted over a respective hinge pin 38U, 38L with the prongs 44 inserted into respective indentations 37 of the receiving members 32U, 32L. The upper hinge pin 38U is exposed such that the prongs 44 of the fastener 42U is snapped directly onto the hinge pin 38U and the receiving member 34U. The lower hinge pin 38L is accessed through a space gap between the hinge pin 38L and the straight end 22 of the front half panel 18A, with one of the prongs 44 inserted through the space gap first and then both prongs 44 are snapped onto the hinge pin 38L and the receiving member 34L. The enlarged ends 45 latch in the indentations 37 thereby locking the fastener 42U, 42L onto a respective receiving member 32U, 32L with the hinge pin 38U, 38L sandwiched in between. So locked, each of the first half panels 18A, 20A are free to rotate from about 0 to 90 degrees about a vertical axis defined by the hinge pins 38U, 38L relative to the front panel 14 as the cart 10 collapses and opens.

The receiving members 32U, 32L, the insertion members 34U, 34L and the fasteners 42U, 42L of the hinge assemblies 28A, 28B provide a simple and straight-forward manner by which the cart 10 can be assembled. There is little risk of the hinge assemblies 28A, 28B disassembling as the fasteners 42U, 42L are intended to be nonreleasable fastener once installed on the receiving members 32U, 32L. That is, once the enlarged ends 45 are snapped into the indentations 37, there is no direct means by which the enlarged ends can be released from the indentations. In the illustrated embodiment, the enlarged ends 45 curve inwardly toward the hinge pin 38U, 38L and are covered entirely by the surrounding receiving members 32U, 32L and thus hidden within the indentations 37 and therefore inaccessible for release. The enlarged ends 45 have a smooth outer surface such that the outer surface is free from any feature which could act as a catch by which a tool can be used to release or dislodge the enlarged ends 45 from the indentations 37 without damage to the fastener or the receiving members.

As understood in the art, the receiving portion 29 and its receiving members 32U, 32L may be integrated with or be a portion of the front panel 13, and the insertion portion 31 and its insertion members 34U, 34L may be integrated with or be a portion of the side panel 18, 20, such as during construction via injection molding.

In the illustrated embodiment, there are two hinge assemblies in every corner, a top hinge assembly and a bottom hinge assembly in vertical alignment, for a total of eight hinge assemblies in the cart 10.

The hinge assemblies (also referred to as “split hinge assemblies”) provide the collapsible cart with modular assembly and disassembly of connected panels and components, offering versatility and simplicity of installation. Notably, no tools are required for installation or adjustment and the hinge assemblies enable tool-free installation, streamlining assembly and maintenance procedures. The hinge assembly design allows for greater versatility for positioning within diverse structures or assemblies. It removes the requirement for additional tools during assembly and addresses concerns regarding tool accessibility.

In some embodiments, the cart 10 includes a telescoping handle 50 (FIG. 1) integrated with the back panel 16 which can assume a shortened stored configuration or an extended deployed configuration. In some embodiments, the cart 10 includes caster wheels 52 (FIG. 1) mounted along a bottom edge of the rear panel 16.

When the cart 10 is fully expanded, the bottom panel 12 is in the horizontal position at the bottom of the cart. Before the cart is collapsed, the bottom panel 12 is first lifted via its handhold opening 60 (FIG. 2) and moved into an upright vertical position, where it is stored behind the front panel 14, under an upper flange 62 of the front panel 14. Thereafter, an inwardly-directed force is applied to each hinge joint 30 to fold the front and rear half panels 18A, 18B, 20A, 20B inwardly along the hinge joints 30. Simultaneously, the hinge assemblies 28A enable the front half panels 18A, 20A to fold toward the front panel 14 from about 90 degrees to 0 degrees, and the hinge assemblies 28B enable the rear half panels 18B, 20B to fold toward the rear panel 16 from about 90 degrees to 0 degrees. To expand the cart 10, the actions described above may be taken in reverse order.

It is understood that the hinge assembly has utility and applications beyond a collapsible cart. The advantages provided by the hinge assemblies described above may be applied to any device, particularly, devices manufactured by injection molding, where there is a desire for transition between an expanded configuration and a collapsed configuration by means of folding.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those skilled in the art in view of the teachings herein. Such modifications and variations are intended to be included within the scope of the claims.

Having shown and described various versions of the present invention, further adaptations of the methods and systems described herein may be accomplished by appropriate modifications by one skilled in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/WE claim:

1. A collapsible cart movable between a collapsed configuration and an expanded configuration, comprising:
a front panel, a rear panel, a first side panel and a second side panel configured to form a rectangular shape with four corners; and
a plurality of hinge assembly, each hinge assembly located at a respective corner and including:
a receiving member;
an insert member with a hinge; and
a nonreleasable fastener configured to lock the hinge to the receiving member in enabling adjacent panels of the respective corner to move between about 0 to 90 degrees relative to each other.

2. The collapsible cart of claim 1, further comprising a bottom panel configured for stowage next to and parallel with the front panel when the collapsible cart is in the collapsed configuration.

3. The collapsible cart of claim 1, wherein the receiving member includes an open channel configured to receive the hinge.

4. The collapsible cart of claim 1, wherein the nonreleasable fastener includes at least one prong with an enlarged end that is configured for engagement with an indentation formed in the receiving member.

5. The collapsible cart of claim 4, wherein the enlarged end when inserted into the indentation is surrounded in its entirety by the receiving member.

6. The collapsible cart of claim 1, further comprising caster wheels.

7. The collapsible cart of claim 1, further comprising handles.

8. The collapsible cart of claim 1, wherein each hinge assembly includes:
a second receiving member;
a second insert member with a second hinge in vertical alignment with the hinge; and
a second nonreleasable fastener configured to lock the second hinge to the second receiving member.

9. The collapsible cart of claim 1, the collapsible cart includes components constructed by injection molding.

10. A collapsible cart configured to move between a collapsed configuration and an expanded configuration, comprising:
a front panel;
a rear panel;
a bottom panel;
a first side panel and a second side panel; and
a plurality of hinge assembly, each hinge assembly, including:
a receiving member with a channel and side indentations;
an insert member with a hinge configured to sit in the channel; and
a nonreleasable fastener configured with prongs and enlarged ends configured to engage with the side indentations in locking the hinge in the channel.

11. The collapsible cart of claim 10, wherein the front panel, the rear panel and the first and side panels are configured to form a rectangular shape with corners, a respective hinge assembly situated in a respective corner.

12. The collapsible cart of claim 11, wherein each respective hinge assembly pivotably couples adjacent panels at each corner in enabling the adjacent panels to move between at least 0 and 90 degrees relative to each other.

13. The collapsible cart of claim 10, wherein each of the first side panel and the second side panel comprises a front half panel, a rear half panel, and a hinge joint movably coupling the front half panel and the rear half panel.

14. The collapsible cart of claim 10, including a bottom panel configured for stowage next to and parallel with the front panel when the collapsible cart is in the collapsed configuration.

15. A collapsible cart configured to move between a collapsed configuration and an expanded configuration, comprising:
four panels configured to form a rectangular shape with four corners, each corner comprising a pair of first and second hinged panels; and
a plurality of nonreleasable fasteners,
wherein the first hinged panel has a first edge comprising upper and lower channels and the second hinged panel has a second edge comprising upper and lower hinges, each hinge configured to sit in a respective channel, and each nonreleasable fastener configured to lock a respective hinge in a respective channel in enabling each pair of first and second hinged panels to move about 0 to 90 degrees relative to each other.

16. The collapsible cart of claim 15, wherein two opposing panels of the four panels comprises two half panels, each of the two half panels hinged to each other by hinge joints that are configured to enable each of the two half panels to move between about 0 to 180 degrees relative to each other.

17. The collapsible crate of claim 15, wherein the four panels and the plurality of nonreleasable fasteners are injection molded.

18. The collapsible crate of claim 15, wherein the cart includes a bottom panel configured for stowage next to and parallel with the front panel when the collapsible cart is in the collapsed configuration.

19. The collapsible cart of claim 15, wherein each of the nonreleaseable fastener has enlarged ends, and the first hinged panel includes indentations configured to receive the enlarged ends, each indentation configured to surround a respective enlarged end in its entirety.

20. The collapsible cart of claim 15, further including telescopic handles mounted to one of the panels.
